(19) United States
(12) Patent Application Publication
(10) Pub. No.: US 2014/0117243 A1
(43) Pub. Date: May 1, 2014

(54) METHOD OF INSPECTING AN ELECTROMAGNETIC RADIATION SENSING PANEL, AN ELECTROMAGNETIC RADIATION SENSING PANEL INSPECTION DEVICE AND METHOD OF MANUFACTURING AN ELECTROMAGNETIC RADIATION DETECTOR

(71) Applicant: Samsung Display Co., Ltd., Yongin-City (KR)

(72) Inventor: Tae Jin Hwang, Yongin-city (KR)

(73) Assignee: Samsung Display Co., Ltd., Yongin-City (KR)

(21) Appl. No.: 13/922,142

(22) Filed: Jun. 19, 2013

(30) Foreign Application Priority Data
Oct. 30, 2012 (KR) 10-2012-0121479

(51) Int. Cl. G01T 7/00

(52) U.S. Cl. CPC G01T 7/00
USPC 250/362; 250/216

(57) ABSTRACT

In an aspect, a method and device of inspecting an electromagnetic radiation sensing panel and a method of manufacturing an electromagnetic radiation detector are provided. The method includes generating converted electromagnetic radiation by irradiating incident electromagnetic radiation onto an electromagnetic radiation conversion layer, measuring the generated converted electromagnetic radiation and evaluating data regarding the converted electromagnetic radiation, generating converted electromagnetic radiation based on the data regarding the converted electromagnetic radiation, and irradiating the generated converted electromagnetic radiation onto an electromagnetic radiation sensing panel.

### CROSS-REFERENCE TO RELATED APPLICATION

This application claims priority to and the benefit of from Korean Patent Application No. 10-2012-0121479 filed on Oct. 30, 2012 in the Korean Intellectual Property Office, the disclosure of which is incorporated herein by reference in its entirety.

### BACKGROUND

1. Field

The present disclosure relates to a method of inspecting an electromagnetic radiation (EMR) sensing panel, an inspection device of an electromagnetic radiation sensing panel and a method of manufacturing an electromagnetic radiation detector.

2. Description of the Related Technology

An electromagnetic radiation detector senses electromagnetic radiation and analyzes information of incident electromagnetic radiation. A representative exemplary electromagnetic radiation detector is an X-ray detector.

An X-ray detector is a device that detects an amount of transmitted X-rays that travel through an object e.g. human body. Before the advent of the digital computer and before the development of digital imaging, a photographing system was used to produce most radiographic images. The X-ray detector may be generally used as a medical testing device and as a non-destructive testing device.

In early days, a film or computed radiography (CR) was used in X-ray photographing systems for producing an image. In recent years, X-ray photographing systems have employed a digital radiography (DR) because of convenience in use.

An X-ray detector based on the DR method, which includes a scintillator, indirectly measures the amount of detected X-rays by converting irradiated X-rays into visible light and allowing a photoelectric conversion element to convert the visible light into an electrical signal.

In order to check the performance of the X-ray detector, a scintillator layer is combined with a light sensing panel and X rays are irradiated. However, when a failure is detected, it is difficult to identify whether the failure is detected from the light sensing panel or the scintillator layer. Further, even if it is identified that the failure is detected only from the light sensing panel, it is quite difficult to recycle the scintillator layer combined with the light sensing panel.

### SUMMARY

Some embodiments provide a method of inspecting an electromagnetic radiation sensing panel.

Some embodiments provide a device for inspecting an electromagnetic radiation sensing panel.

Some embodiments provide a method of manufacturing an electromagnetic radiation detector.

The above and other objects of the present embodiments will be described in or be apparent from the following description.

According to an aspect of the present embodiments, there is provided a method of inspecting an electromagnetic radiation sensing panel, said method including generating converted electromagnetic radiation by irradiating incident electromagnetic radiation onto an electromagnetic radiation conversion layer, measuring the generated converted electromagnetic radiation and evaluating data of converted electromagnetic radiation, generating converted electromagnetic radiation based on the data about converted electromagnetic radiation, and irradiating the generated converted electromagnetic radiation onto an electromagnetic radiation sensing panel.

According to another aspect of the present embodiments, there is provided a device of inspecting an electromagnetic radiation sensing panel, the inspection device including a converted electromagnetic radiation generator which generates converted electromagnetic radiation, a memory in which a modified electromagnetic radiation spectrum is stored, and a controller which receives the modified electromagnetic radiation spectrum from the memory, determines conditions for generating an electromagnetic radiation spectrum that is the same as or similar to the modified electromagnetic radiation spectrum and transmits the determined conditions to the converted electromagnetic radiation generator.

According to still another aspect of the present embodiments, there is provided a method of manufacturing an electromagnetic radiation detector, the manufacturing method including forming an electromagnetic radiation sensing panel, inspecting the electromagnetic radiation sensing panel before combining an electromagnetic radiation conversion layer on the electromagnetic radiation sensing panel, and fixing the electromagnetic radiation conversion layer on the electromagnetic radiation sensing panel, wherein the inspecting of the electromagnetic radiation sensing panel comprises irradiating converted electromagnetic radiation onto the electromagnetic radiation sensing panel.

Some embodiments provide at least the following effects.

Characteristics of an electromagnetic radiation detector including an electromagnetic radiation conversion layer can be predicted and inspected from an electromagnetic radiation sensing panel having yet to be assembled with the electromagnetic radiation conversion layer. Since inspection is performed in a state in which the electromagnetic radiation detector is not assembled with an electromagnetic radiation conversion layer, the failure can be easily repaired, and disposal expenses can be reduced even when a failure is generated.

The above and other features and advantages of the present embodiments will become more apparent in view of the attached drawings.

### BRIEF DESCRIPTION OF THE DRAWINGS

FIG. 1 is a schematic diagram of an electromagnetic radiation detector manufactured according to an embodiment;

FIG. 2 is a flow chart illustrating processing steps of a method for manufacturing an electromagnetic radiation detector according to an embodiment;

FIG. 3 is a flow chart illustrating a method for predicting and inspecting characteristics of an electromagnetic radiation detector;

FIG. 4 is a schematic diagram illustrating a step of a method for producing electromagnetic radiation spectrum;

FIG. 5 is a schematic diagram illustrating another step of a method for evaluating data of converted electromagnetic radiation; and

FIG. 6 is a schematic diagram of an inspecting device of an electromagnetic radiation sensing panel according to an embodiment.

### DETAILED DESCRIPTION

The present disclosure will now be described more fully hereinafter with reference to the accompanying drawings, in which preferred embodiments of this disclosure are shown. This disclosure may, however, be embodied in many different forms and is not construed as limited to the exemplary embodiments set forth herein. Rather, these embodiments are provided so that this disclosure will be understood by those skilled in the art.

It will be understood that when an element or layer is referred to as being “on” another element or layer, it can be directly on the other element or layer or intervening elements or layers may be present. Like numbers refer to like elements throughout.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present embodiments.

Throughout the specification, when multiple processing steps are referred to as being parallel processed, unless otherwise defined, the sequence of performing the respective processing steps is not limited to the sequence set forth herein.

Throughout the specification, the term “electromagnetic radiation” or “beam” may have the same meaning as electromagnetic wave.

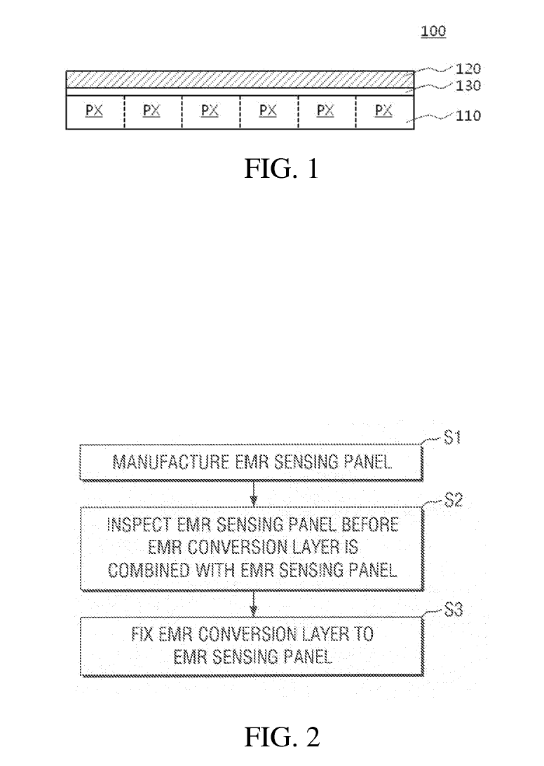

FIG. 1 is a schematic diagram of an electromagnetic radiation detector manufactured according to an embodiment.

Referring to FIG. 1, the electromagnetic radiation detector 100 may be a device that detects electromagnetic radiation. In some embodiments, the electromagnetic radiation detector 100 records the intensity of incident electromagnetic radiation. In some embodiments, the incident electromagnetic radiation may include X-rays, visible light, infrared rays, ultraviolet rays, and so on. In some embodiments, the incident electromagnetic radiation may include gamma rays, radio waves, micro waves, ultrahigh frequency waves, and so on. In exemplary embodiments, the incident electromagnetic radiation may be electromagnetic radiation transmitted through an object. In some embodiments, the electromagnetic radiation information detected by the electromagnetic radiation detector 100 can be used to analyze particular information. For example, information on an object density by region may be analyzed and can be used in inferring or diagnosing component materials of the object. In some exemplary embodiments, the electromagnetic radiation detector 100 may be an X-ray detector for detecting X-rays as incident electromagnetic radiation.

In some embodiments, the electromagnetic radiation detector 100 may include an electromagnetic radiation sensing panel 110 and an electromagnetic radiation conversion layer 120. In some embodiments, the electromagnetic radiation sensing panel 110 may change a wavelength of an electromagnetic wave incident onto the electromagnetic radiation conversion layer 120. For example, the electromagnetic radiation sensing panel 110 may increase or decrease the wavelength of incident electromagnetic wave. In some embodiments, the electromagnetic radiation conversion layer 120 may receive incident electromagnetic radiation selected from the group consisting of gamma rays, X-rays, ultraviolet rays, visible light, infrared rays, and electric waves and may convert the selected electromagnetic radiation into another type of electromagnetic radiation selected from the group. In a case where the electromagnetic radiation detector 100 is an X-ray detector, X-rays may be used as the incident electromagnetic radiation of the electromagnetic radiation conversion layer 120, and the electromagnetic radiation conversion layer 120 may convert the incident X-rays into visible light. In some embodiments, the electromagnetic radiation conversion layer 120 may include a scintillator layer including cesium iodine (CsI), gadolinium oxysulfide (GOS), etc.

The electromagnetic radiation sensing panel 110 may receive the converted electromagnetic radiation from the electromagnetic radiation conversion layer 120 and senses the received electromagnetic radiation. The electromagnetic radiation conversion layer 120 may include a photoelectric conversion unit (not shown) that converts the received electromagnetic radiation into an electric signal. The photoelectric conversion unit may include a photoelectric conversion device (not shown). Examples of the photoelectric conversion device may include a photodiode such as a hydrogenated amorphous silicon (a-Si:H) PIN diode, or a photo transistor.

The electromagnetic radiation sensing panel 110 may include a plurality of pixels PX. At least one of the photoelectric conversion device may be arranged for each pixel PX.

The electromagnetic radiation sensing panel 110 may further include a driver (not shown). The driver may include a driving Integrated Circuit (IC) (not shown). The driving IC of the driver may analyze intensity of the electric signal received for each pixel PX and may analyze intensity of incident electromagnetic radiation received in the electromagnetic radiation conversion layer 120 based on the analyzed electric signal intensity. The analyzed information may be transmitted to a display (not shown) to be displayed.

The driving IC may be directly formed on a substrate having the pixels PX. Alternatively, the driving IC may be formed on another member to then be attached to a substrate. For example, the driving IC may be mounted on a flexible printed circuit film attached to the substrate, may be attached in the form of a tape carrier package (TCP), or may be mounted on a printed circuit board attached to the substrate.

In some embodiments, the electromagnetic radiation sensing panel 110 may further include a plurality of signal lines (not shown) transmitting the electric signal generated from the photoelectric conversion device to the driver and a switching device (not shown). Each one of the switching device may be provided for each pixel PX, but aspects of the present invention are not limited thereto.

In some embodiments, the electromagnetic radiation conversion layer 120 is attached to the electromagnetic radiation sensing panel 110 and then assembled therewith. One example method of attaching the electromagnetic radiation conversion layer 120 to the electromagnetic radiation sensing panel 110 is to interpose an adhesive layer 130 between the electromagnetic radiation conversion layer 120 and the electromagnetic radiation sensing panel 110. In some embodiments, the adhesive layer 130 may be formed on the entire surface of the electromagnetic radiation conversion layer 120 or may be formed long edges of the electromagnetic radiation conversion layer 120. When the adhesive layer 130 is formed on the entire surface of the electromagnetic radiation conversion layer 120, the adhesive layer 130 is made of a material capable of transmitting the electromagnetic radiation converted by the electromagnetic radiation conversion layer 120. Examples of the material forming the adhesive layer 130 may include, but not limited to, silicon or an optically clear adhesive (OCA). The electromagnetic radiation conversion layer 120 may be fixed onto the electromagnetic radiation sensing panel 110 by means of the adhesive layer 130.

In other embodiments, a sealing layer (not shown) may be formed on the electromagnetic radiation conversion layer 120 to adhesively combine the electromagnetic radiation conversion layer 120 with the electromagnetic radiation sensing panel 110. For example, in a state in which the electromagnetic radiation conversion layer 120 is placed on the electromagnetic radiation sensing panel 110, a protecting glass may be positioned on the electromagnetic radiation conversion layer 120 and edges of the protecting glass are attached or mechanically combined with a electromagnetic radiation conversion layer assembled with the electromagnetic radiation sensing panel 110. Accordingly, since a mounting space for the electromagnetic radiation conversion layer 120 is limited, the electromagnetic radiation conversion layer 120 may not readily move on the electromagnetic radiation sensing panel 110 but may be fixed thereon. In this case, the adhesive layer 130 may not be interposed between the electromagnetic radiation sensing panel 110 and the electromagnetic radiation conversion layer 120.

An example method of forming the electromagnetic radiation detector 100 is shown in FIG. 2. FIG. 2 is a flow chart illustrating processing steps of a method for manufacturing an electromagnetic radiation detector according to an embodiment of the present invention.

Referring to FIGS. 1 and 2, the method for manufacturing a electromagnetic radiation detector according to an embodiment of the present invention includes forming an electromagnetic radiation sensing panel 110 (S1), inspecting the electromagnetic radiation sensing panel 110 having yet to be assembled with the electromagnetic radiation conversion layer 120 (S2), and fixing the electromagnetic radiation conversion layer 120 on the electromagnetic radiation sensing panel 110 (S3).

In the forming of the electromagnetic radiation sensing panel 110 (S1), an object to be inspected by the electromagnetic radiation sensing panel 110 is formed, and a general method that is well known in the art may be used in the forming of the electromagnetic radiation sensing panel 110 (S1). The formed electromagnetic radiation sensing panel 110 may be an electromagnetic radiation sensing panel with a driving IC installed therein or may be an electromagnetic radiation sensing panel having yet to be assembled with a driving IC. In the former case, the driving IC may be used in confirming the inspection result in the inspecting step to be described later. In the latter case, a probe, instead of the driving IC, may be used in confirming the inspection result in the inspecting step to be described later.

In some embodiments, the inspecting of the electromagnetic radiation sensing panel 110 (S2) may include a first inspecting step of inspecting characteristics of the electromagnetic radiation sensing panel 110 having yet to be assembled with the electromagnetic radiation conversion layer 120 and a second inspecting step of predicting and inspecting characteristics of the electromagnetic radiation detector 100.

In some embodiments, the first inspecting step may include inspecting the electromagnetic radiation sensing panel 110 for abnormal appearance and inspecting photoelectric conversion processing.

In some embodiments, the inspecting for abnormal appearance includes inspecting stains appearing on the electromagnetic radiation sensing panel 110 or presence or absence (or extents) of defects. In some embodiments, the inspecting for abnormal appearance may be performed by directly observing the appearance by naked eye or by magnifying the electromagnetic radiation sensing panel 110 using a magnifier and observing the same by naked eye. Alternatively, stains appearing on the electromagnetic radiation sensing panel 110 or presence or absence (or extents) of defects may be inspected by photographing outer appearance of the electromagnetic radiation sensing panel 110 using a camera and observing the acquired image by naked eye, or by analyzing whether programmed standards of the electromagnetic radiation sensing panel 110 are satisfied or not using a computer.

In some embodiments, the inspecting of photoelectric conversion signal processing may include evaluating the photoelectric conversion unit, evaluating signal lines or switching devices in the electromagnetic radiation sensing panel 110, and evaluating the driving IC. Some of the evaluating steps may be skipped. For example, when the electromagnetic radiation sensing panel 110 to be inspected is an electromagnetic radiation sensing panel having yet to be assembled with the driving IC, the evaluating of the driving IC may be obviously skipped. In addition, items of the photoelectric conversion signal processing to be evaluated may be added or reduced according to necessity.

In some embodiments, the evaluating of the photoelectric conversion unit may include evaluating whether incident electromagnetic radiation for each pixel PX is well converted into an electric signal or not and whether photoelectric conversion efficiency is uniform for each pixel PX or not. In some embodiments, the evaluating of the signal lines or switching devices provided in the electromagnetic radiation sensing panel 110 may include evaluating whether the signal lines or switching devices provided in the electromagnetic radiation sensing panel 110 normally transmit the electric signal converted for each pixel PX or not, whether a resistance value for each pixel PX is uniform or not, and whether there is leakage current or not. In some embodiments, the evaluating of the driving IC may include evaluating signal processing or analyzing capability of the driving IC for the transmitted electric signal.

In some embodiments, the evaluating of the photoelectric conversion unit, the evaluating of the signal lines or switching devices provided in the electromagnetic radiation sensing panel 110 and the evaluating of the driving IC may be performed at once by a single inspecting step. For example, when the electromagnetic radiation conversion layer 120 assembled with the electromagnetic radiation sensing panel 110 in a subsequent step includes a scintillator layer capable of converting the X-ray into visible electromagnetic radiation, the visible electromagnetic radiation may be irradiated onto the entire surface of the electromagnetic radiation sensing panel 110, an amount of the electric signal transmitted to the driver may be measured, transmitted to the display and then analyzed. Based on the measuring and analyzing results, it can be evaluates whether steps of photoelectric conversion, signal transmission, signal processing and analyzing have been normally performed. As the result, defects of pixels PX or lines can be detected.

When the electromagnetic radiation sensing panel 110 has yet to be assembled with a driving IC, the electric signal is measured using a probe, thereby evaluating whether photoelectric conversion and signal transmission have been normally performed. In some embodiments, the visible light irradiated onto the entire surface of the electromagnetic radiation sensing panel 110 may be triple-wavelength visible light.

Inspecting of the photoelectric conversion signal processing may further include evaluating charging/discharging of the electromagnetic radiation sensing panel 110, evaluating reducibility, and evaluating aging performance. In some embodiments, the evaluating steps may be achieved by repeating the inspecting process multiple times or performing the steps under harsh conditions in terms of temperature or humidity.

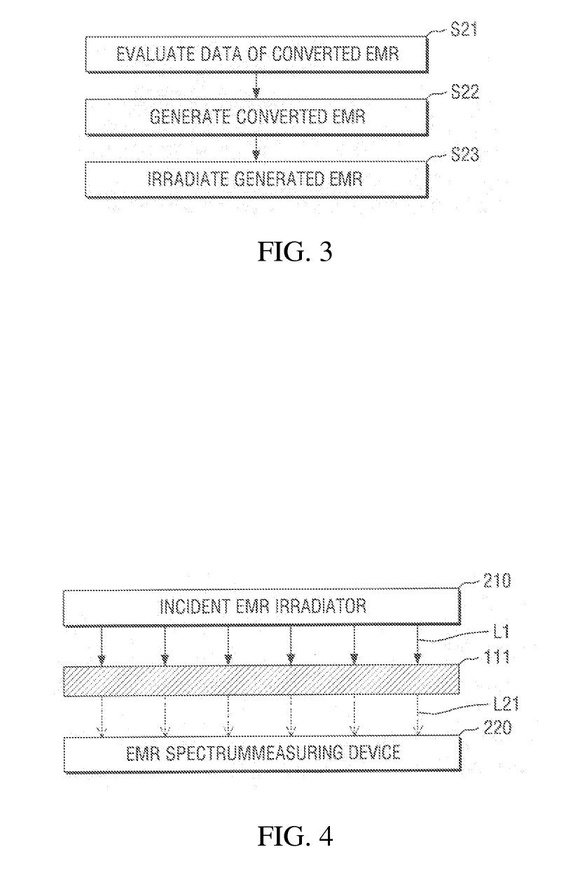

The second inspecting step is used in predicting and inspecting characteristics of the electromagnetic radiation detector 100, which will be described in more detail with reference to FIG. 3.

FIG. 3 is a flow chart illustrating a method for predicting and inspecting characteristics of a electromagnetic radiation detector.

Referring to FIGS. 1 and 3, the second inspecting step includes evaluating data concerning converted electromagnetic radiation (S21), generating converted electromagnetic radiation (S22), and irradiating the generated converted electromagnetic radiation (S23).

In the evaluating of the data concerning converted electromagnetic radiation (S21), data concerning electromagnetic radiation converted from incident electromagnetic radiation through the electromagnetic radiation conversion layer 120 is determined.

FIG. 4 is a schematic diagram illustrating a step of a method for producing electromagnetic radiation spectrum.

Referring to FIGS. 3 and 4, an electromagnetic radiation conversion layer 120 is prepared and an incident electromagnetic radiation irradiator 210 used for the actual electromagnetic radiation detector 100 is installed at one side of the electromagnetic radiation conversion layer 120. Optionally, an object (not shown) may be positioned between the incident electromagnetic radiation irradiator 210 and the electromagnetic radiation conversion layer 120. In addition, an electromagnetic radiation spectrum measuring device 220 is positioned at the other side of the electromagnetic radiation conversion layer 120. The electromagnetic radiation spectrum measuring device 220 may include an electromagnetic radiation wavelength measuring device such as an electromagnetic radiation intensity measuring device or an oscilloscope.

Next, the incident electromagnetic radiation irradiator 210 irradiates electromagnetic radiation L1 onto the electromagnetic radiation conversion layer 120, and the electromagnetic radiation spectrum measuring device 220 measures converted electromagnetic radiation L21 having passed through the electromagnetic radiation conversion layer 120. Subsequently, converted electromagnetic radiation data with information on the incident electromagnetic radiation L1 matched with the electromagnetic radiation measuring result is determined.

In some embodiments, the information on the incident electromagnetic radiation L1 may include intensity, wavelength, spectrum, irradiation time and irradiation frequency of the incident electromagnetic radiation L1, incidence angle with respect to the electromagnetic radiation conversion layer 120. In addition, in a case where an object exists between the incident electromagnetic radiation irradiator 210 and the electromagnetic radiation conversion layer 120, the information on the incident electromagnetic radiation L1 may further include position, size, thickness and density of the object.

In some embodiments, the electromagnetic radiation measuring result may include intensity and wavelength of the converted electromagnetic radiation L21. In some embodiments, the intensity and wavelength of the converted electromagnetic radiation may be simultaneously measured by installing an electromagnetic radiation amount measuring device and an electromagnetic radiation wavelength measuring device at once or may be separately measured under the same condition of the incident electromagnetic radiation L1.

Measurement of the converted electromagnetic radiation L21 according to irradiation of incident electromagnetic radiation L1 may be performed multiple times. In some embodiments, the electromagnetic radiation measuring result may be matched for different conditions of incident electromagnetic radiation L1. In a case where different electromagnetic radiation measuring results are produced for the same condition of incident electromagnetic radiation L1, representative values, including a mean, a median, and a mode of multiple electromagnetic radiation measuring results, may be matched with the corresponding incident electromagnetic radiation conditions.

Therefore, the finally determined data of converted electromagnetic radiation L21 may include information on intensity and wavelength of the converted electromagnetic radiation L21 corresponding to various conditions of incident electromagnetic radiation L1.

Referring again to FIG. 3, in the generating of the converted electromagnetic radiation (S22), converted electromagnetic radiation is generated based on the determined converted electromagnetic radiation data. In some embodiments, an electromagnetic radiation spectrum for each condition of incident electromagnetic radiation may be produced based on information on intensity and wavelength of the determined converted electromagnetic radiation data.

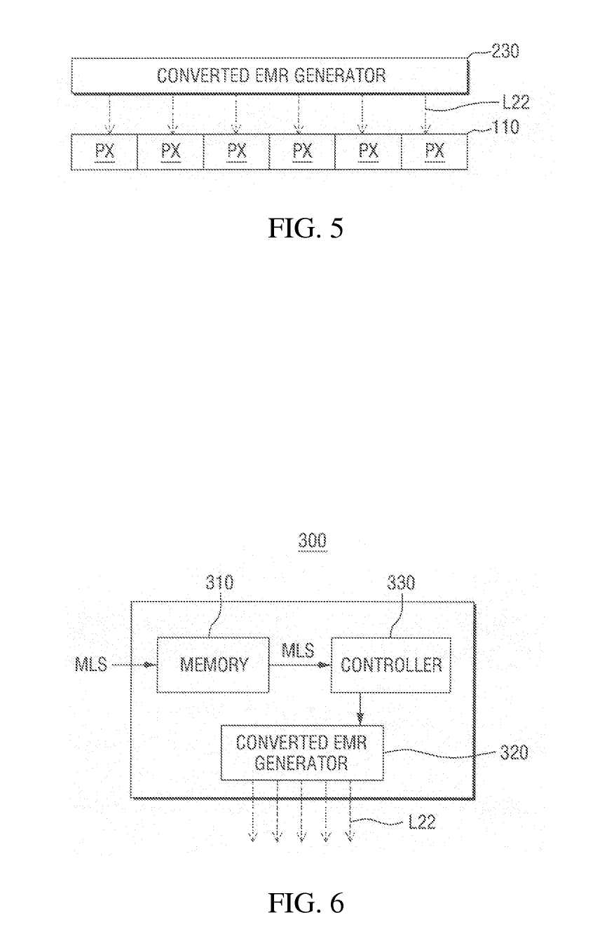

If the electromagnetic radiation spectrum is produced, a combination of an electromagnetic radiation source and an optical filter, which can demonstrate spectrum that is the same as or similar to the produced electromagnetic radiation spectrum, and electromagnetic radiation intensity are detected, and a converted electromagnetic radiation generator (230 of FIG. 5) corresponding thereto is then prepared. Here, examples of the electromagnetic radiation source may include, but not limited to, a single wavelength laser, a diode, a light emitting diode (LED), an organic light emitting device (OLED), and other triple-wavelength visible light sources. The optical filter may be used to produce an electromagnetic radiation spectrum that is the same or maximally similar to the produced electromagnetic radiation spectrum. For example, when the produced electromagnetic radiation spectrum has a wavelength in a range of 500 to 600 nm, the same as or similar to the produced electromagnetic radiation spectrum may be generated using a converted electromagnetic radiation generator including a triple-wavelength visible light source and a green filter. For more fine tuning of electromagnetic radiation spectrums, the converted electromagnetic radiation generator may employ a combination of another electromagnetic radiation source and/or another optical filter, e.g., a combination of single-wavelength lasers. Further details of the method of generating the electromagnetic radiation that is the same as or maximally similar to the produced electromagnetic radiation spectrum are widely known in the related art, and a detailed description will be omitted.

In the irradiating of the generated converted electromagnetic radiation (S23), the generated converted electromagnetic radiation is irradiated onto the electromagnetic radiation sensing panel 110 using a combination of an electromagnetic radiation source and an optical filter.

FIG. 5 is a schematic diagram illustrating another step of a method for producing converted electromagnetic radiation data.

Referring to FIGS. 1, 3 and 5, the converted electromagnetic radiation generator 230 is disposed at one side of the electromagnetic radiation sensing panel 110 having yet to be assembled with the electromagnetic radiation conversion layer 120. Here, the relationship between the converted electromagnetic radiation generator 230 and the electromagnetic radiation sensing panel 110, for example, distance or electromagnetic radiation incidence angle, is substantially the same as the relationship between the incident electromagnetic radiation irradiator 210 and the electromagnetic radiation spectrum measuring device 220, as shown in FIG. 4. Here, although the electromagnetic radiation sensing panel 110 is yet to be assembled with the electromagnetic radiation conversion layer 120, substantially the same condition as the condition under which the electromagnetic radiation sensing panel 110 is assembled with the electromagnetic radiation conversion layer 120. Therefore, when various types of the converted electromagnetic radiation L22 are irradiated onto the electromagnetic radiation sensing panel 110 and characteristics of the electromagnetic radiation sensing panel 110 are evaluated, incident electromagnetic radiation is irradiated under the corresponding incident electromagnetic radiation condition after being assembled with the electromagnetic radiation conversion layer 120, and substantially the same result as the result obtained by evaluating characteristics of the electromagnetic radiation detector 100 can be obtained. That is to say, even before the electromagnetic radiation sensing panel 110 is assembled with the electromagnetic radiation conversion layer 120, it is possible to predict and inspect the characteristics of the electromagnetic radiation sensing panel 110 assembled with the electromagnetic radiation conversion layer 120. The method of irradiating various types of the converted electromagnetic radiation L22 onto the electromagnetic radiation sensing panel 110 and evaluating characteristics of the electromagnetic radiation sensing panel 110 may be substantially the same as the method of inspecting the photoelectric conversion signal processing of the electromagnetic radiation sensing panel 110.

Examples of inspection based on irradiation of the generated converted electromagnetic radiation L22 may include inspection of the resolution, sensitivity and noise spectrum of the electromagnetic radiation detector 100. The inspection items and methods thereof may be substantially the same as those of a general electromagnetic radiation detector, except for the type of incident electromagnetic radiation and whether or not the electromagnetic radiation sensing panel 110 is assembled with the electromagnetic radiation conversion layer 120. Although the electromagnetic radiation sensing panel 110 is inspected by irradiating the generated converted electromagnetic radiation L22, the inspection result is substantially the same as the results obtained from inspection of the resolution, sensitivity, and noise spectrum of the electromagnetic radiation detector 100 including the electromagnetic radiation conversion layer 120.

As the inspection result, it is determined that the electromagnetic radiation sensing panel 110 is abnormal or failed, the electromagnetic radiation sensing panel 110 may be repaired or discarded. Since the electromagnetic radiation sensing panel 110 is yet to be assembled with electromagnetic radiation conversion layer 120, it is obvious that the electromagnetic radiation sensing panel 110 may be easily repaired. In a case where the electromagnetic radiation sensing panel 110 is discarded, since the electromagnetic radiation sensing panel 110 is disposed of before it is assembled with the electromagnetic radiation conversion layer 120 that is expensive, the processing expenses can be reduced.

In the above-described embodiment, the irradiating of the generated converted electromagnetic radiation (S23) and the predicting and inspecting of the electromagnetic radiation detector 100 may be independently performed for each electromagnetic radiation sensing panel 110 to be inspected. Once the evaluating of the data of the converted electromagnetic radiation (S21) and the generating of the converted electromagnetic radiation (S22) are performed under particular incident electromagnetic radiation conditions, they may not need to be repeatedly performed on different electromagnetic radiation sensing panels 110 to be inspected. However, the results obtained in the previously performed inspecting steps can still be utilized.

Referring again to FIG. 2, the electromagnetic radiation conversion layer 120 is kept at a state in which it is fixed on the electromagnetic radiation sensing panel 110, thereby completing the electromagnetic radiation detector 100. For example, the electromagnetic radiation conversion layer 120 may be fixed on the electromagnetic radiation sensing panel 110 by first forming the adhesive layer 130 on one surface of the electromagnetic radiation sensing panel 110 or on the other surface of the electromagnetic radiation conversion layer 120, and the electromagnetic radiation conversion layer 120 and the adhesive layer 130 are then stacked one on another.

Since the inspection of characteristics of the completed electromagnetic radiation detector 100, for example, inspection of resolution, sensitivity and noise spectrum, has been already predicted and evaluated when the electromagnetic radiation sensing panel 110 having yet to be assembled with the electromagnetic radiation conversion layer 120 is inspected, repeated inspection may be skipped. However, in order to confirm the inspection result performed in the previous inspection step, inspection of the resolution, sensitivity and noise spectrum of the completed electromagnetic radiation detector 100 may be performed again. The inspection may be performed by a general inspecting method well known in the related art. In addition, when a failure occurs during the inspection, it is possible to easily predict that a failure occurs to the electromagnetic radiation conversion layer 120.

Hereinafter, an inspecting device used in inspecting the electromagnetic radiation sensing panel 110 will be described.

FIG. 6 is a schematic diagram of an inspecting device of an electromagnetic radiation sensing panel according to an embodiment of the present invention.

Referring to FIG. 6, the inspecting device 300 of an electromagnetic radiation sensing panel according to an embodiment of the present invention includes a memory 310, a converted electromagnetic radiation generator 320, and a controller 330.

In some embodiments, the converted electromagnetic radiation generator 320 may include at least one electromagnetic radiation source and/or an optical filter.

Modified electromagnetic radiation spectrums (MLS) depending on various incident electromagnetic radiation conditions are input and stored in the memory 310. Here, the MLS may be spectrums for the electromagnetic radiation converted after incident electromagnetic radiation is irradiated onto the electromagnetic radiation conversion layer 120 and passes through the electromagnetic radiation conversion layer 120.

In some embodiments, the controller 330 may receive the MLS depending on a particular incident electromagnetic radiation condition from the memory 310 and may deduce conditions for generating an electromagnetic radiation spectrum that is the same as or similar to the MLS, including, for example, a combination of an electromagnetic radiation source and/or optical filter and electromagnetic radiation intensity, to then transmit the determined conditions to the converted electromagnetic radiation generator 320.

In some embodiments, the converted electromagnetic radiation generator 320 selects the combination of an electromagnetic radiation source and/or optical filter and the electromagnetic radiation intensity corresponding to the determined condition received from the controller 330 and emits the converted electromagnetic radiation L22.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims. It is therefore desired that the present embodiments be considered in all respects as illustrative and not restrictive, reference being made to the appended claims rather than the foregoing description to indicate the scope of the invention.

What is claimed is:

1. A method of inspecting an electromagnetic radiation sensing panel, the method comprising:
generating converted electromagnetic radiation by irradiating incident electromagnetic radiation onto an electromagnetic radiation conversion layer, measuring the generated converted electromagnetic radiation and evaluating data of converted electromagnetic radiation;
generating converted electromagnetic radiation based on the data of converted electromagnetic radiation; and
irradiating the generated converted electromagnetic radiation onto an electromagnetic radiation sensing panel.

2. The method of claim 1, wherein the electromagnetic radiation sensing panel includes a plurality of pixels, each including at least one photoelectric conversion unit.

3. The method of claim 1, wherein the incident electromagnetic radiation is an X-ray, and the converted electromagnetic radiation is visible light.

4. The method of claim 3, wherein the electromagnetic radiation conversion layer includes a scintillator layer.

5. The method of claim 1, wherein the generating of the converted electromagnetic radiation comprises:
producing an electromagnetic radiation spectrum from the data of the converted electromagnetic radiation; and
detecting at least one electromagnetic radiation source capable of indicating the electromagnetic radiation spectrum.

6. The method of claim 5, wherein the electromagnetic radiation source is a single wavelength laser, a diode, a light emitting diode (LED), an organic light emitting device (OLED), or a triple-wavelength visible light source.

7. The method of claim 5, wherein the detecting comprises detecting a combination of at least one electromagnetic radiation source and an optical filter to indicate the electromagnetic radiation spectrum.

8. The method of claim 1, wherein the irradiating of the generated converted electromagnetic radiation onto the electromagnetic radiation sensing panel is performed without intervention of the electromagnetic radiation conversion layer.

9. The method of claim 1, further comprising predicting and inspecting characteristics of the electromagnetic radiation detector including the electromagnetic radiation sensing panel assembled with the electromagnetic radiation conversion layer by measuring results of irradiating the generated converted electromagnetic radiation onto the electromagnetic radiation sensing panel.

10. The method of claim 9, wherein the characteristics of the electromagnetic radiation detector include at least one of resolution, sensitivity and noise spectrum of the electromagnetic radiation detector with the electromagnetic radiation conversion layer assembled therewith.

11. The method of claim 1, further comprising performing inspecting the electromagnetic radiation sensing panel for an abnormal appearance and inspecting a photoelectric conversion signal processing of the electromagnetic radiation sensing panel.

12. A device for inspecting an electromagnetic radiation sensing panel, the inspection device comprising:
a converted electromagnetic radiation generator which generates converted electromagnetic radiation;
a memory in which a modified electromagnetic radiation spectrum is stored; and
a controller which receives the modified electromagnetic radiation spectrum from the memory, determines conditions for generating an electromagnetic radiation spectrum that is the same as or similar to the modified electromagnetic radiation spectrum and transmits the determined conditions to the converted electromagnetic radiation generator.

13. The inspection device of claim 12, wherein the converted electromagnetic radiation generator includes at least one electromagnetic radiation source.

14. The inspection device of claim 13, wherein the electromagnetic radiation source is a single wavelength laser, a diode, a light emitting diode (LED), an organic light emitting device (OLED), or a triple wavelength visible light source.

15. The inspection device of claim 13, wherein the converted electromagnetic radiation generator further includes an optical filter.

16. A method of manufacturing an electromagnetic radiation detector, the manufacturing method comprising:
forming an electromagnetic radiation sensing panel;
inspecting the electromagnetic radiation sensing panel before combining an electromagnetic radiation conversion layer on the electromagnetic radiation sensing panel; and
fixing the electromagnetic radiation conversion layer on the electromagnetic radiation sensing panel,
wherein the inspecting of the electromagnetic radiation sensing panel comprises irradiating converted electromagnetic radiation onto the electromagnetic radiation sensing panel.

17. The method of claim 16, wherein the electromagnetic radiation sensing panel includes a plurality of pixels, each including at least one photoelectric conversion unit.

18. The method of claim 16, before irradiating the converted electromagnetic radiation onto the electromagnetic radiation sensing panel, further comprising:
generating converted electromagnetic radiation by irradiating incident electromagnetic radiation onto the electromagnetic radiation conversion layer, measuring the generated converted electromagnetic radiation and evaluating data concerning the converted electromagnetic radiation; and
generating the converted electromagnetic radiation based on the data concerning the converted electromagnetic radiation.

19. The method of claim 18, wherein the incident electromagnetic radiation are X-rays, the converted electromagnetic radiation is visible light, and the electromagnetic radiation detector is an X-ray detector.

20. The method of claim 16, wherein the generating of the converted electromagnetic radiation comprises:
producing an electromagnetic radiation spectrum from the data concerning the converted electromagnetic radiation; and
detecting at least one electromagnetic radiation source capable of indicating the electromagnetic radiation spectrum.

21. The method of claim 16, wherein the inspecting of the electromagnetic radiation sensing panel further comprises performing inspecting the electromagnetic radiation sensing panel for abnormal appearance and inspecting a photoelectric conversion signal processing of the electromagnetic radiation sensing panel.
